(19) United States
(12) Patent Application Publication
(10) Pub. No.: US 2020/0395891 A1
(43) Pub. Date: Dec. 17, 2020

(54) SOLAR PANEL HEATING SYSTEM AND METHOD

(71) Applicant: The University of Massachusetts, Boston, MA (US)

(72) Inventors: Sam Mil'shtein, Chelmsford, MA (US); Mukhammaddin Zinaddinov, Lowell, MA (US); Dhawal Asthana, Lowell, MA (US); Maksym Ushakov, Lowell, MA (US)

(21) Appl. No.: 16/903,747

(22) Filed: Jun. 17, 2020

Related U.S. Application Data
(60) Provisional application No. 62/862,654, filed on Jun. 17, 2019.

(51) Int. Cl. H02S 40/44; H02S 40/32; H02S 40/12

(52) U.S. Cl. CPC H02S 40/44; H02S 40/12; H02S 40/32

(57) ABSTRACT

A photovoltaic system is disclosed. The system includes a solar panel adapted for operative connection to a power sink for delivery of electric power from the solar panel to the power sink. The system also includes a power transfer circuit in operative communication with the solar panel. The power transfer circuit is adapted for connection to an AC power supply, and the power transfer circuit is configured to transfer current at a forward-biased voltage to a first terminal of the solar panel in response to a first half-cycle portion (e.g., a first of a positive or negative voltage portion) of the alternating current supplied to the solar panel and to prevent transmission of current to the first terminal of the solar panel in response to a second half-cycle portion (e.g., a second of the positive or negative voltage portion) of the alternating current.

This application claims the benefit of an earlier filing date from U.S. Provisional Application Ser. No. 62/862,654 filed Jun. 17, 2019, the entire disclosure of which is incorporated herein by reference.

### BACKGROUND

The subject matter disclosed herein relates to photovoltaic systems, and, more particularly, to heating of solar panels such as for snow or ice removal.

A desire for power-generating system alternatives to conventional steam-driven turbine systems has led to the development of photovoltaic systems that include solar panels capable of generating direct current (DC) power. In some cases, solar panels can be installed in large groups also known as panel farms. In some cases, solar panels can be also installed individually or in small groups, such as for residential roof-top applications. Solar panels can also be interconnected through a power converter circuit to an alternating current (AC) power grid, or can be connected with a DC power sink such as a DC lighting circuit.

Regardless of installation configuration, solar panels installed outdoors are exposed to the elements, and in conditions below the freezing point of water can be subject to the accumulation of snow, frost, or ice on surfaces of the solar panels, which can interfere with light impacting on photovoltaic elements in the panel, thus interfering with the production of electric power. Various approaches have been taken in an attempt to mitigate the accumulation of forms of frozen water on solar panels. For example, steeper angles have been proposed, but such angles may be less than optimum for exposure to solar energy, and may still allow for accumulation of ice, frost, and even snow. Water-repelling nano-textured surfaces have been proposed, but can be subject to surface damage or fouling. Additionally, nano-textured surfaces can be expensive and may be impractical for large-scale panel farms. Externally-attached or integrated heating elements have been proposed, but these add to the complexity and expense of the system, and can be subject to corrosion or cause other maintenance problems. It has also been proposed to apply DC current directly to the photovoltaic elements of the solar panels to cause an output of heat. This approach, however, requires either an outside DC power source such as a battery that is charged when the panels are in power production mode and is discharged when the panels are in a snow removal mode. However, such batteries are subject to limitations on operating duration, have a limited life span, can be prohibitively expensive if properly sized for expected snow or icing events, and add to system complexity and maintenance. JP 2000-165940A discloses a different DC power source in the form of a bi-directional converter that converts DC current generated by the panel to AC current transferred to a power grid, and in a snow removal mode acts as an inverter to convert AC current from the grid to DC power applied to the photovoltaic elements of the panels. However, this system involves added complexity from the inclusion of inverter circuitry, which adds to system cost, complexity, and maintenance.

### BRIEF DESCRIPTION

According to an aspect of the disclosure, a photovoltaic system includes a solar panel adapted for operative connection to a power sink for delivery of electric power from the solar panel to the power sink. The system also includes a power transfer circuit in operative communication with the solar panel. The power transfer circuit is adapted for connection to an AC power supply, and the power transfer circuit is configured to transfer current at a forward-biased voltage to a first terminal of the solar panel in response to a first half-cycle portion (e.g., a first of a positive or negative voltage portion) of the alternating current supplied to the solar panel and to prevent transmission of current to the first terminal of the solar panel in response to a second half-cycle portion (e.g., a second of the positive or negative voltage portion) of the alternating current.

In some aspects, the power transfer circuit is further configured to operate in a first mode of operation in which transmission of current from the AC power supply to the solar panel is prevented, and a second mode of operation in which transmission of current from the AC power supply to the solar panel is permitted.

In some aspects, an electronic controller is programmed to alternately operate the power transfer circuit in one of the first mode of operation and the second mode of operation in response to a system command or an operating condition of the photovoltaic system.

In some aspects, the electronic controller is programmed to operate the power transfer circuit in the second mode of operation in response to a frozen water condition at a surface of the solar panel, and to operate the power transfer circuit in the first mode of operation in response to an operating condition in which the frozen water condition is not present at the surface of the solar panel.

In some aspects, the system command or operating condition is based on a criteria selected from a frozen water sensor in operative communication with the surface of the solar panel, a local weather condition sensor in operative communication with the electronic controller, a current reported weather conditions, weather forecast information, a sunlight sensor, a timer, a pre-determined pattern of operating in the first and second modes of operation, or a combination comprising any of the foregoing.

In some aspects, a sensor is configured to detect a frozen water condition on a surface of the solar panel.

In some aspects, the sensor includes at least one of an optical color sensor, a photodetector sensor, an ultrasonic sensor, a conductivity or impedance sensor, a temperature sensor, and a humidity sensor.

In some aspects, the frozen water condition represents a layer of snow on the surface of the solar panel.

In some aspects, the power sink includes an alternating current power grid, and the system optionally includes an inverter in operative communication with the solar panel adapted for connection to the alternating current power grid.

In some aspects, the power sink includes a local direct current power sink.

In some aspects, the power transfer circuit is arranged and configured to transmit a positive half-cycle portion of the alternating current to a positive terminal of the solar panel, and to transmit a negative half-cycle portion of the alternating current to a negative terminal of the solar panel.

In some aspects, a plurality of solar panels is in operative communication with the power transfer circuit, wherein the power transfer circuit is arranged and configured to transmit a positive half-cycle portion of the alternating current to a positive terminal of a first solar panel of the plurality of solar panels, and to transmit a negative half-cycle portion of the alternating current to a negative terminal of a second solar panel of the plurality of solar panels.

Also discloses is a method of removing or preventing a frozen water condition on a solar panel includes transmitting current from an AC power supply to the solar panel in response to a first half-cycle portion of alternating current from the AC power supply, and preventing transmission of current to the solar panel in response to a second half-cycle portion of alternating current from the AC power supply.

In some aspects, the method includes operating in a first mode of operation in which transmission of both first half-cycle and second half-cycle portions of the alternating current from the AC power supply to the solar panel are prevented, and a second mode of operation in which transmission of the first half-cycle portion of the alternating current is permitted and transmission of the second half-cycle portion of the alternating current is prevented.

In some aspects, the method includes operating in the second mode of operation in response to a frozen water condition at a surface of the solar panel, and operating in the first mode of operation in response to an operating condition in which a frozen water condition is not present at the surface of the solar panel.

In some aspects, the method's determination of the frozen water condition is based on a criteria selected from one of a frozen water sensor in operative communication with the surface of the solar panel, a local weather condition sensor in operative communication with the electronic controller, a current reported weather conditions, weather forecast information, a sunlight sensor, a timer, and a pre-determined pattern of operating in the first and second modes of operation.

In some aspects, the method's determination of the frozen water condition includes detecting at least one of a presence of ice and a presence of snow on the surface of the solar panel.

In some aspects, the method's determination of the frozen water condition is based on a sensor selected from one of an optical color sensor, a photodetector sensor, an ultrasonic sensor, a conductivity, an impedance sensor, a temperature sensor, and a humidity sensor.

In some aspects, the method includes transmitting a positive half-cycle portion of the alternating current to a positive terminal of the solar panel, and transmitting a negative half-cycle portion of the alternating current to a negative terminal of the solar panel.

In some aspects, the method includes transmitting a positive half-cycle portion of the alternating current to a positive terminal of a first solar panel, and transmitting a negative half-cycle portion of the alternating current to a negative terminal of a second solar panel to alleviate the frozen water condition on each of the first and second solar panels.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an example embodiment of a photovoltaic system with a single panel;

FIG. 2 is a schematic diagram of another example embodiment of a photovoltaic system with a single panel;

FIG. 3 is a schematic diagram of yet another example embodiment of a photovoltaic system with two panels;

FIG. 4 is a schematic diagram of yet another example embodiment of a photovoltaic system with multiple panels;

FIG. 5 is a schematic diagram of a protocol for operation of a photovoltaic system; and

FIG. 6 is a schematic diagram of an example embodiment of a frozen water sensor.

The detailed description explains embodiments of the invention, together with advantages and features, by way of example with reference to the drawings.

### DETAILED DESCRIPTION

In some aspects, the photovoltaic systems and methods described herein can promote removal of frozen water (e.g., snow, frost, ice) from a solar panel by heating it. Photovoltaic solar panels act as p-i-n photodiodes operating in the reverse bias region (third quadrant of I-V characteristics) in the power generation mode. According to this disclosure, a forward bias voltage applied to this p-i-n photodiode can induce conduction of current through the photodiode and heating of the solar panel to promote removal of frozen water.

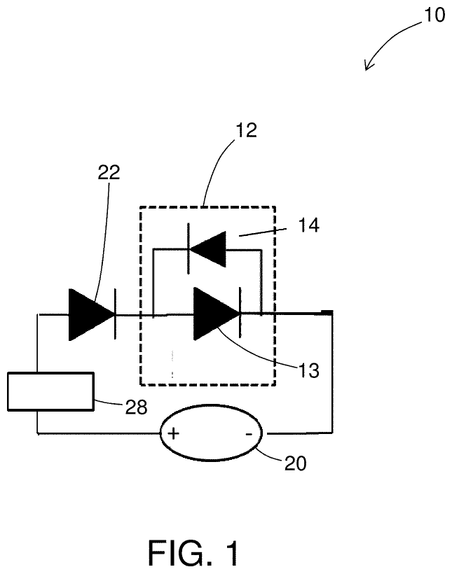

With reference now to the Figures, FIG. 1 shows a schematic block diagram of a photovoltaic system 10 according to an example aspect of the disclosure. As shown in FIG. 1, the photovoltaic system 10 includes a solar panel 12 that includes a first p-i-n photodiode element 13 and a first bypass diode 14. The solar panel 12 is typically connected to a power sink (not shown) that receives electrical power from the solar panel 12, e.g., a local DC power sink (e.g., a lighting circuit) or an inverter for connected to an AC power sink such as an AC power grid. An AC power source 20, a bypass current blocking diode 22, and a switch 28 are connected to the photodiode element 13 to provide a forward voltage bias to the photodiode element during a positive half-cycle portion of the alternating current provided by the AC power source 20. The voltage level can vary, but in some aspects it can be within the panel's designed voltage output range. The AC power supply 20 can be fed by single or multi-phase AC voltage and in some aspects can output up to 20 A of current per panel. During operation for frozen water removal or prevention, switch 28 is closed so that current from the AC power source 20 is conducted through the bypass current blocking diode 22 and the photodiode 13 to cause heating of the photodiode 13 and solar panel 12. The bypass current blocking diode 22 blocks transmission of current during the negative half-cycle of the alternating current so that no current is transmitted to the solar panel 12 during the negative half-cycle.

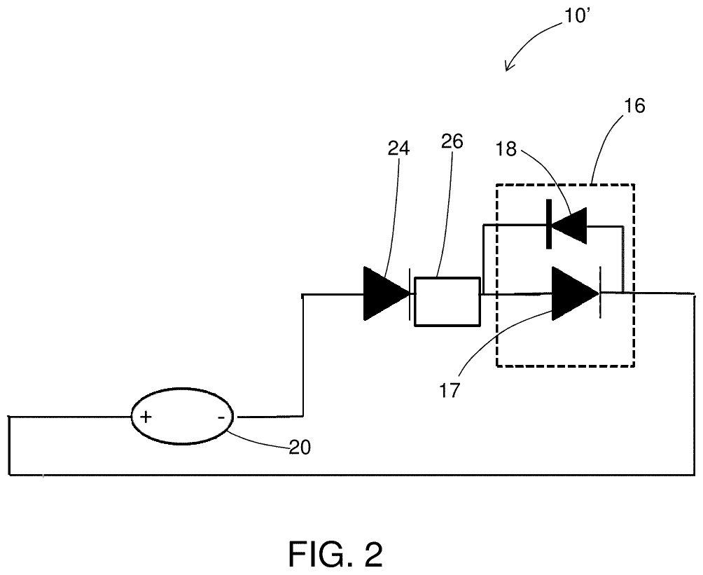

The system in FIG. 1 is configured with a connection between a positive terminal of the AC power source 20 and a positive terminal of the solar panel 12, and utilizes current from the positive half-cycle of the alternating current for frozen water mitigation. In another aspect, the positive terminal of the AC power source 20 can be connected to a negative terminal of a solar panel to utilize current from the negative half-cycle of the alternating current for frozen water mitigation. Such an embodiment is presented in FIG. 2, which shows system 10′ with a second solar panel 16 that includes a second p-i-n photodiode element 17 and a second bypass diode 18. The AC power source 20, a bypass current blocking diode 24, and a switch 26 are connected to the photodiode element 17 to provide a forward voltage bias to the photodiode element during a negative half-cycle portion of the alternating current provided by the AC power source 20. During operation for frozen water removal or prevention, switch 26 is closed so that current from the AC power source 20 is conducted through the bypass current blocking diode 24 and the photodiode 17 to cause heating of the photodiode 17 and solar panel 16. The bypass current blocking diode 24 blocks transmission of current during the positive half-cycle of the alternating current so that no current is transmitted to the solar panel 16 during the positive half-cycle.

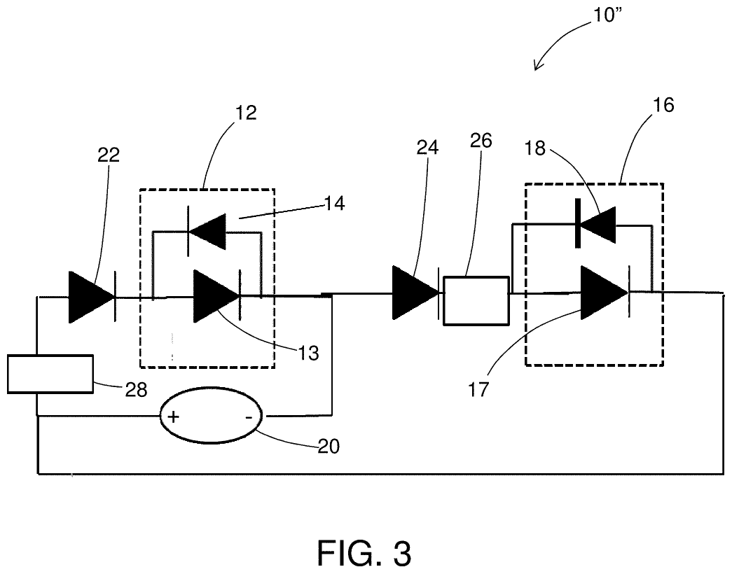

In some aspects, the photovoltaic system can include solar panels with both positive-to-positive AC connections and positive-to-negative AC connections. Such an embodiment is presented in FIG. 3, which shows a system including both of the solar panels 12 and 16, along with their associated components. During frozen water mitigation operation, the switches 26 and 28 can be opened and closed in coordination with the AC power wave to apply forward-biased voltage alternately to the photodiodes 13 and 17 from the positive half-wave and negative half-wave portions of the alternating current, respectively. Alternatively, the switches 26 and 28 can be left closed during frozen water mitigation operation, and the bypass current blocking diodes 22 and 24 can control the transmission alternately between the photodiodes 13 and 17.

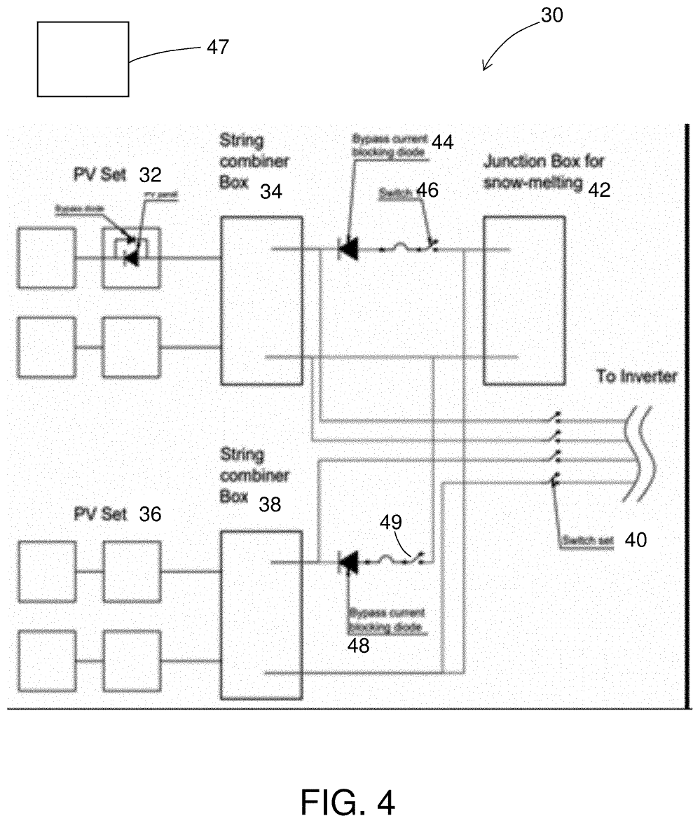

In some aspects, the solar panels can be disposed in a panel farm connected through an inverter to an AC power grid. Such a photovoltaic system 30 is presented in FIG. 4. As shown in FIG. 4, a first set of photovoltaic solar panels 32 is connected through a string combiner box 34 and a switch set 40 to an inverter for delivery of power produced by the set of panels 32 to an AC power grid (not shown). A second set of photovoltaic solar panels 36 is connected through a string combiner box 38 and the switch set 40 to the inverter for delivery of power produced by the set of panels 34 to the AC power grid (not shown). A junction box 42 provides auxiliary AC power to the panel farm site (which can be from the AC power grid to which the panels are connected through the inverter) or can be from another source of AC power. AC power from the junction box 42 can be transmitted to the set of solar panels 32 through a bypass current blocking diode 44 and a switch 46, and can be transmitted to the set of solar panels 36 through a bypass current blocking diode 48 and a switch 49, to provide forward bias voltage to each of the panel sets 32 and 36, respectively. Additional panels or sets of panels (not shown) can also be included. During normal operation, the switch set 40 connects the solar arrays to the solar inverter, and during frozen water mitigation, the switches connects the solar arrays to the AC junction box 42. During frozen water mitigation operation, the circuit makes use of bypass current blocking diodes 44 and 48 connected in series with the solar panel sets 32 and 36, respectively, which allows flow of current only through the solar panels 32, 36 and not the bypass diodes connected in antiparallel to each of them as shown in FIG. 4. When frozen water mitigation is switched on by means of switches 46, 49, and disconnection switch of the power generating circuit through switch set 40, the photovoltaic solar panel set 32 and the photovoltaic solar panel set 36 alternatively conduct current during the positive and the negative halve-cycles of the AC power supply, respectively. These switches can be operated remotely and/or automatically such as by a controller 47, which can include a microprocessor programmed with instructions for carrying out the protocol(s) described herein.

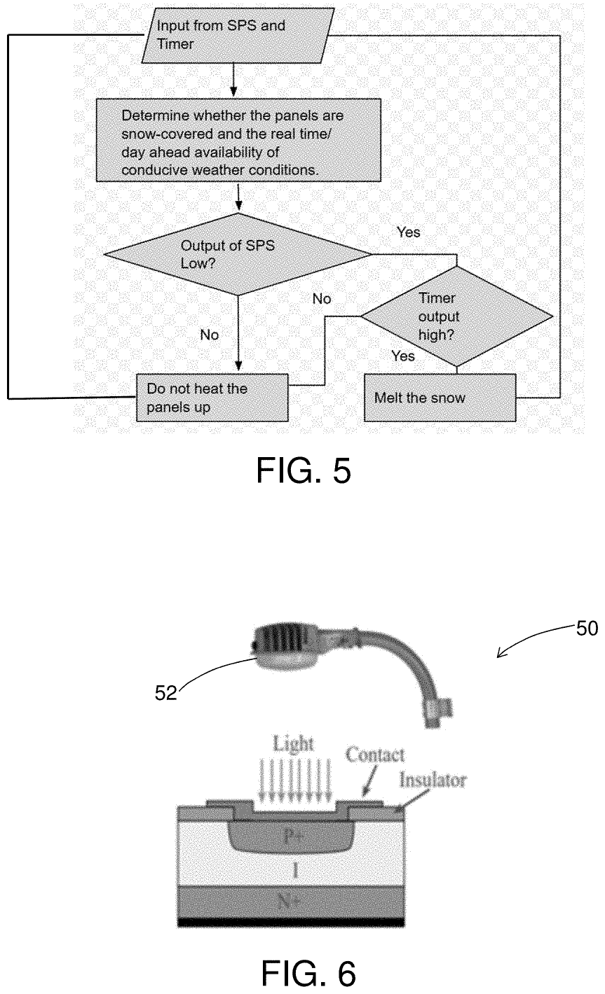

A determination to activate frozen water mitigation can be made by the controller 47 according to various criteria. In some aspects, the determination to activate frozen water mitigation can be based on any one or combination of criteria selected from elapsed time (e.g., a timer), local sensor data indicative of a frozen water condition or on a surface of the solar panel, weather data (current data or forecast) available (e.g., over the internet). An example aspect of an operational protocol is presented in FIG. 5. As shown in FIG. 5, input is received from a timer and a surface profile sensor (SPS) capable of detecting a frozen water condition on a solar panel surface. The operation moves to the next block to determine whether the panels are experiencing a frozen water condition based on the sensor and timer input, along with optional data received about current and/or expected weather conditions. If output of the SPS is low (e.g., below a threshold (either a predetermined threshold or a calculated threshold based on other data such as weather conditions, temperature, etc.)) and the timer is high (e.g., above a threshold (either a predetermined threshold or a calculated threshold based on other data such as weather conditions, temperature, etc.)), then frozen water mitigation is initiated and operational control is looped back to the beginning. If the output of the SPS is high (e.g., above a threshold (either a predetermined threshold or a calculated threshold based on other data such as weather conditions, temperature, etc.)) or the output of the timer is not high (e.g., below a threshold (either a predetermined threshold or a calculated threshold based on other data such as weather conditions, temperature, etc.)), then frozen water mitigation is not initiated and operational control is looped back to the beginning.

Various types of sensors can be used to assess whether a frozen water condition is present. Some sensors may directly detect the presence of frozen water (e.g., a surface profile sensor or SPS), and some sensors may instead detect conditions favorable for the formation of frozen water (e.g., temperature, humidity). Examples of sensors that can directly detect the presence of frozen water (i.e., primary sensors) include but are not limited to color sensors (e.g., RGB sensors) that can be used to detect a white layer snow over surface of the solar panel which appears blue otherwise. Photodetector-based sensors include an arrangement with a glowing LED bulb directed towards a photodetector such as shown in FIG. 6 for sensor 50 with an LED bulb 52 directed toward a photodetector. This photodetector can be placed over the surface of the solar panels. In such a case, the output of this sensor will be low whenever the light emitted by the LED is obstructed by a layer of frozen water that accumulates over the surface of the panels. Other types of primary sensors can include conductance/impedance sensors or ultrasonic sensors, or camera-based sensors coupled with image processing software written to recognize images of frozen water. Secondary sensors that collect data that may be indicative of a frozen water condition include but are not limited to estimations of availability of adequate solar irradiance ahead of time to be carried out by means of hourly and day-ahead weather forecast data which is made available for use in applications and can be accessed over the internet via the API (Application Programming Interface). Other secondary sensors can include but are not limited to elapsed time sensors (also known as timers), sun sensors (which can provide additional economic advantage to the overall system by ensuring that the snow melting circuitry is switched on at instances when there is enough irradiance available for harvesting), temperature sensors, humidity sensors, and various other sensors as well.

Other aspects of the disclosure are provided in the attached paper entitled “Cost-Effective Snow Removal from Solar Panels”, submitted herewith as Appendix A to the specification, the disclosure of which is made a part hereof and is incorporated herein by reference in its entirety.

While the subject matter herein has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope thereof. Additionally, while various example embodiments have been described, it is to be understood that aspects of the disclosure may include only some of the described embodiments. Accordingly, the disclosure is not to be seen as limited by the foregoing description, but is only limited by the scope of the appended claims.

1. A photovoltaic system, comprising:
a solar panel adapted for operative connection to a power sink for delivery of electric power from the solar panel to the power sink; and
a power transfer circuit in operative communication with the solar panel, said power transfer circuit adapted for connection to an AC power supply, said power transfer circuit configured to transfer current at a forward-biased voltage to a first terminal of the solar panel in response to a first half-cycle portion of the alternating current supplied to the solar panel and to prevent transmission of current to the first terminal of the solar panel in response to a second half-cycle portion of the alternating current.

2. The photovoltaic system according to claim 1, wherein the power transfer circuit is further configured to operate in a first mode of operation in which transmission of current from the AC power supply to the solar panel is prevented, and a second mode of operation in which transmission of current from the AC power supply to the solar panel is permitted.

3. The photovoltaic system according to claim 2, further comprising an electronic controller programmed to alternately operate the power transfer circuit in one of the first mode of operation and the second mode of operation in response to a system command or an operating condition of the photovoltaic system.

4. The photovoltaic system according to claim 3, wherein the electronic controller is programmed to operate the power transfer circuit in the second mode of operation in response to a frozen water condition at a surface of the solar panel, and to operate the power transfer circuit in the first mode of operation in response to an operating condition in which the frozen water condition is not present at the surface of the solar panel.

5. The photovoltaic system according to claim 3, wherein the system command or operating condition is based on a criteria selected from a frozen water sensor in operative communication with the surface of the solar panel, a local weather condition sensor in operative communication with the electronic controller, a current reported weather conditions, weather forecast information, a sunlight sensor, a timer, a pre-determined pattern of operating in the first and second modes of operation, or a combination comprising any of the foregoing.

6. The photovoltaic system according to claim 1, further comprising a sensor configured to detect a frozen water condition on a surface of the solar panel.

7. The photovoltaic system according to claim 6, wherein the sensor includes at least one of an optical color sensor, a photodetector sensor, an ultrasonic sensor, a conductivity or impedance sensor, a temperature sensor, and a humidity sensor.

8. The photovoltaic system according to claim 6, wherein the frozen water condition represents a layer of snow on the surface of the solar panel.

9. The photovoltaic system according to claim 1, wherein the power sink includes an alternating current power grid, and the system optionally includes an inverter in operative communication with the solar panel adapted for connection to the alternating current power grid.

10. The photovoltaic system according to claim 1, wherein the power sink includes a local direct current power sink.

11. The photovoltaic system according to claim 1, wherein the power transfer circuit is arranged and configured to transmit a positive half-cycle portion of the alternating current to a positive terminal of the solar panel, and to transmit a negative half-cycle portion of the alternating current to a negative terminal of the solar panel.

12. The photovoltaic system according to claim 1, further comprising: a plurality of solar panels in operative communication with the power transfer circuit, wherein the power transfer circuit is arranged and configured to transmit a positive half-cycle portion of the alternating current to a positive terminal of a first solar panel of the plurality of solar panels, and to transmit a negative half-cycle portion of the alternating current to a negative terminal of a second solar panel of the plurality of solar panels.

13. A method of removing or preventing a frozen water condition on a solar panel, comprising:
transmitting current from an AC power supply to the solar panel in response to a first half-cycle portion of alternating current from the AC power supply; and
preventing transmission of current to the solar panel in response to a second half-cycle portion of alternating current from the AC power supply.

14. The method according to claim 13, further comprising operating in a first mode of operation in which transmission of both first half-cycle and second half-cycle portions of the alternating current from the AC power supply to the solar panel are prevented, and a second mode of operation in which transmission of the first half-cycle portion of the alternating current is permitted and transmission of the second half-cycle portion of the alternating current is prevented.

15. The method according to claim 14, further comprising operating in the second mode of operation in response to a determination of a frozen water condition at a surface of the solar panel, and operating in the first mode of operation in response to an operating condition in which a frozen water condition is not present at the surface of the solar panel.

16. The method according to claim 15, wherein determination of the frozen water condition is based on a criteria selected from one of a frozen water sensor in operative communication with the surface of the solar panel, a local weather condition sensor in operative communication with the electronic controller, a current reported weather conditions, weather forecast information, a sunlight sensor, a timer, and a pre-determined pattern of operating in the first and second modes of operation.

17. The method according to claim 16, wherein determination of the frozen water condition includes detecting at least one of a presence of ice and a presence of snow on the surface of the solar panel.

18. The method according to claim 16, wherein determination of the frozen water condition is based on a sensor selected from one of an optical color sensor, a photodetector sensor, an ultrasonic sensor, a conductivity, an impedance sensor, a temperature sensor, and a humidity sensor.

19. The method according to claim 14, further comprising transmitting a positive half-cycle portion of the alternating current to a positive terminal of the solar panel, and transmitting a negative half-cycle portion of the alternating current to a negative terminal of the solar panel.

20. The method according to claim 14, further comprising transmitting a positive half-cycle portion of the alternating current to a positive terminal of a first solar panel, and transmitting a negative half-cycle portion of the alternating current to a negative terminal of a second solar panel to alleviate the frozen water condition on each of the first and second solar panels.
